(19) United States
(12) Patent Application Publication
(10) Pub. No.: US 2010/0208192 A1
(43) Pub. Date: Aug. 19, 2010

(54) LC FILLING AND LAMINATION METHOD

(75) Inventors: Akihiro Mochizuki, Louisville, CO (US); Shinichi Kuroda, Zama-shi (JP)

Correspondence Address: MORRISON & FOERSTER LLP, 1650 TYSONS BOULEVARD, SUITE 400, MCLEAN, VA, 22102, US

(73) Assignee: Nano Loa, Inc., Kawasaki-shi (JP)

(21) Appl. No.: 12/388,975

(22) Filed: Feb. 19, 2009

(51) Int. Cl. G02F 1/1333

(52) U.S. Cl. 349/189

(57) ABSTRACT

A process for producing a liquid crystal display device comprising Smectic liquid crystal material, comprising: providing an LC panel comprising a pair of substrates; and filling the space between the pair of substrates with a Smectic liquid crystal material, while adjusting the liquid crystal molecular primary axis along with the pre-set or pre-designed alignment direction, and while adjusting the liquid crystal moving direction in the space between the pair of substrates at the filling of the Smectic liquid crystal material along with the pre-set alignment direction.

### BACKGROUND OF THE INVENTION

1. Field of the Invention

The present invention relates to a manufacturing method of liquid crystal display devices, particularly liquid crystal filling and panel lamination process.

2. Related Background Art

Recent increase in application field of liquid crystal displays (LCDs) shows many varieties such as an LCD for smart phones, net personal digital assistance (PDA), computer monitors, and large screen direct view TVs. These emergent increases in application field are based on recent LCDs improvement in their performance and in their manufacturability.

On the other hand, new flat panel display technologies such as Organic Light Emission Displays (OLEDs), Plasma Display Panels (PDPs) have been accelerated in their development and manufacturing to compete with LCDs. Moreover, introduction to new application field of LCDs requests new and higher performance in their image quality to meet with these new application fields. In particular, most of recent emergent application fields require full-color motion video image without any motion image blur, which is still difficult to conventional LCD technology in terms of slow response nature of conventional LCDs.

Under the above given circumstances, LCDs are being required higher performance, in particular faster optical response in order to expand their application field competing with new flat panel display technologies which all have faster optical response performance than current LCD technologies. Followings are detail descriptions of concrete requirement at each particular application field to new LCD technologies. Moreover, effective manufacturing process to meet with higher image quality is also of great concern for volume manufacturing of LCDs. There are several causes for current conventional LCD technologies could not get lid of above poor image quality issues. Slow response time, limited viewing angle and higher manufacturing cost with expensive bill of materials cost are reasons of the issue.

This Invention intends to provide an effective and reasonable solution to get lid of above issues for current LCD technologies are facing.

General Technical Problems of Current LCD Technologies

One of the strongest demands to get lid of above poor image quality in conventional LCDs is to have much faster optical response. A much faster optical response provides both intrinsic and additional means to an LCD having much better image quality. Due to slow optical response of conventional LCD technologies, it is extremely difficult to obtain well enough full motion video image quality without showing motion image blur. Moreover, limited viewing angle of conventional LCD technologies require additional or external optical compensation which pushes up manufacturing cost of LCDs.

In order to give an intrinsic solution to above problems, an introduction of faster optical response LCD technology is necessary. Couples of much faster optical response LCD technologies than conventional LCD technologies have been proposed and being developed. However, one of the most difficult issues in use of these newer LCD technologies is their incompatibility in volume manufacturing with current well established volume LCD.

In particular, most of newer or much faster LCD technologies use different types of liquid crystal materials such as ferroelectric liquid crystal materials, Smectic A phase materials, Chiral Nematic materials, and PSS-LC materials. Most of these newer LC materials show much higher viscosity than those of current conventional LC materials. Therefore, an effective liquid crystal filling process is of an urgent requirement. Moreover, current most effective liquid crystal filling process is directly connected or combined with panel lamination process, so that above newer LC materials need to satisfy effective enough or high manufacturing throughput process both in LC filling and panel lamination process.

Specific Technical Issue of Current Technologies

Liquid crystal filling process as well as lamination process has been one of the most time consuming process in the series of LCD volume manufacturing. Since LC filing process is not simply filling process of liquid crystal materials. Conventional liquid crystal filling process always has some sort of side effects in it process. One example of the side effects is that panel gap change and unevenness in a panel. Since surface tension between liquid crystal material and alignment surface works both for expansion and for shrinkage of panel gap during and after the LC fill depending on the power of the surface tension. When the surface tension is weak, the surface tension power attracts both the substrates, resulting in narrower gap than the original designed.

When the surface tension is strong, the surface tension power spreads out panel gap, resulting in wider panel gap than the original designed. Moreover, more complicated situation is unevenness of panel gap due to unevenness of surface tension during LC filling process. Depending on some multiple conditions at LC fill process, for some reason when surface tension becomes weaker, the area surface tension is weak comes in narrower panel gap, when surface tension becomes stronger, the area surface tension is strong comes in wider panel gap. Regardless LC filling method, conventional LC filling methods have no particular control of surface tension during LC filling process. A vacuum method with pressure difference with in and out of LC panel has a tendency to fill too much liquid crystal materials due to strong surface tension.

Therefore, an LC filled panel by this LC filling method has thicker panel gap than the original designed, and required to be squeezed excess amount of liquid crystal materials. Usually, this squeezing process takes quite long time such as full one day depending on panel size. Not only taking longer time, squeezing liquid crystal materials also requires clean-up process after the squeezing. An ODF method requires extremely sensitive control of surface pre-tilt control of liquid crystal materials. Due to local surface tension effect, an ODF method has a tendency to have uneven pre-tilt angle, resulting in unevenness in image quality. In order to avoid unevenness problem, an ODF method has some improvement such as multiple LC droplets instead of one drop of liquid crystal material.

Decreasing LC droplet size effectively reduces uneven area size. However, this improvement makes unevenness area smaller, and does not give intrinsic solution. Uneven pre-tilt even the size of unevenness is small, provides limited reproduction of fine gray scale. Therefore, regardless LC filling methods, fine control of surface tension is of most intrinsic requirement for high image quality and effective volume manufacturing.

Technical Problem in New Type of LC Materials for Filling Process

Faster optical response liquid crystal drive modes than current commercially available LCDs requires specific liquid crystal materials, and most of the materials have higher viscosity than those of current conventional liquid crystal materials. As a general tendency, higher viscous liquid crystal materials have stronger surface tension power. Therefore, above described technical issues in current conventional LCDs at LC filling/lamination process would be more serious in the higher viscous LC materials. Moreover, some of the new fast optical response liquid crystal drive modes require utilizing Smectic liquid crystal materials.

Unlike conventional Nematic liquid crystal materials, Smectic liquid crystal materials have their characteristic smectic layer structures which give rise to specific order structure in bulk Smectic liquid crystal materials such as translational order. Even chiral nematic liquid crystal materials which are usually classified as a part of Nematic liquid crystal materials also have higher order structure than that of conventional Nematic liquid crystal materials.

One of the significant differences in terms of liquid crystal filling process and panel lamination process in volume manufacturing of LCDs is the viscosity of liquid crystal materials, in particular originated from liquid crystal order structures such as higher order parameter, some specific order such as orientational order and translational order, and so on. For a practical volume manufacturing, in particular for high mfg throughput purpose, higher order parameter of liquid crystal materials is of the most considerable matter.

The Inventors of this Invention have looked into some impact and/or influences of liquid crystal order parameters on the liquid crystal filling and panel lamination process. This Invention has been created through these fundamental researches of nature of liquid crystal order parameters and their dependence of surface tension factors.

Technical Issue this Invention Solves

Technical problems required to be solved by new invention are dependent on actual panel size to be produced. Here, the issue will be discussed both general issue and independent issue depending on produced panel size and LC filling process, panel lamination process.

Smaller Sized Panel Manufacturing

Although it is dependent on manufacturing scale and continuity of products life, in general smaller sized LC panel uses relatively traditional LC filling method. It is using the difference in pressure between panel inside and outside, which is so-called as □gPressure Difference Method□h. The major difference of this method from ODF method in terms of practical process wise, the Pressure Difference Method uses pre-laminated panel to fill liquid crystal materials. On the other hand, the ODF Method combines both LC filling process and panel lamination process.

The major technical issue of the Pressure Difference Method is control of surface tension during LC filling into a laminated empty panel. FIG. 1 illustrates concept of influence of surface tension during LC filling into a laminated empty panel. As described in FIG. 1, the power of surface tension is completely dependent on stage of liquid crystal filling. At the very beginning of LC filling, as illustrated in FIG. 1(a), the surface tension based on liquid crystal invasion to the empty panel is pretty much localized at filling hole area. As the LC filling goes on, the front line of LC invasion spreads out as illustrated in FIG. 1(b).

The absolute power of surface tension is dependent on surface area, so that the stage at FIG. 1(b) shows stronger power of surface tension. On the other hand, the wide spread front line of LC filling makes the resistant power to the surface tension weaker. Because, the resistant power to the surface tension is solely provided by perimeter seal adhesive strength which is usually formed very perimeter edge of the panel. Stronger spread out power from surface tension and relatively weaker resistant power from perimeter seal adhesive strength result in increase of panel gap from originally set one.

This competitive situation between surface tension originated from liquid crystal materials and surface alignment layer and the adhesive strength provided by perimeter seal adhesive strength decides panel gap uniformity and panel gap accuracy from original designed panel gap. In conventional LC filling process based on the Pressure Difference Method requires a squeezing process of excess amount of filled liquid crystal materials. This squeezing process takes not only longer time which reduces mfg throughput, but also has tendency to deteriorate image quality due to unevenness of surface pre-tilt angel during squeezing of excess amount of liquid crystal materials from the panel.

Mechanical force to move filled liquid crystal materials in a panel to outside the panel sometimes could not avoid giving too much mechanical flow stress on the top surface of the alignment layer by the forced flow of liquid crystal materials. Sometimes this forced flow of liquid crystal material gives irreversible damage to the very top surface of alignment layer. Moreover, Chiral Nematic liquid crystal materials, Smectic liquid crystal materials which have higher order structure than conventional Nematic liquid crystal materials require much more careful control of surface tension to avoid any too strong surface tension to keep originally designed set panel gap as well as avoiding any surface stress on the alignment layer.

Larger Sized Panel Manufacturing

Nowadays, most of larger sized liquid crystal panels use an ODF method to fill and laminate LCD panels. The largest advantage of this method is high mfg throughput for larger sized panels. Unlike the Pressure Difference Method, the ODF Method combines both LC filling process and panel lamination process. This is the major advantage of the ODF Method.

In this combined process both with LC filling and panel lamination process, an LC filling process saves significant process time, and results in large mfg throughput. However, this method requires very sensitive control of liquid crystal droplet on the surface of alignment layer. Since pre-tilt of liquid crystal molecules is significantly influenced by the first touch with the top surface of alignment layer. Depending on liquid crystal droplet size, if the droplet size is too large and the droplet is physically pressed to the top surface of alignment layer, the center portion of droplet contact with alignment layer and peripheral portion of droplet contact with alignment layer provide a little bit different pre-tilt angle.

This unevenness with surface pre-tilt angle results in unevenness in screen luminance or “mura”. In order to avoid this unevenness in surface pre-tilt angle problem, recent ODF uses very small liquid crystal droplet size. It is actually, no more “one drop fill”, but “LC shower drop fill”. In spite of this improvement, still unevenness in surface pre-tilt angle with ODF Method needs significant consideration. Moreover, higher anisotropic liquid crystal materials such as Chiral Nematic, Smectic liquid crystal materials require much more sensitive control of the first touch between liquid crystal material and top surface of alignment layer. This significantly careful control of the first touch of liquid crystal droplet makes significant long time for the process.

In particular, making small droplet of Smectic liquid crystal materials may not be easy both to have small and uniform droplet size and maintain small droplet size due to stronger anisotropic nature of Smectic liquid crystal materials than that of Nematic liquid crystal materials. Therefore, in general, it is expected to be extremely difficult to keep small and uniform droplet size with higher order anisotropic liquid crystal materials such as Chiral Nematic liquid crystal materials and Smectic liquid crystal materials.

### SUMMARY OF THE INVENTION

An object of the present invention is to provide a process for producing a liquid crystal display device comprising Smectic liquid crystal material, which can solve a problem encountered in the prior art.

Another object of the present invention is to provide a process for producing a liquid crystal display device comprising Smectic liquid crystal material, which can attain small and uniform droplets of a Smectic liquid crystal material in the process.

As a result of earnest study, the present inventors have found that it is extremely effective in attaining the above object, to adjust LC material's anisotropy as an elastic material with the pre-set LC molecular alignment direction as well as LC filling or spreading direction in an LC panel.

As a result of further earnest study, the present inventors have also found that it is extremely effective in attaining the above object, to apply an external pressure from the outside of the panel during the LC filling process, so as to avoid anonymous Marangoni flow due to surface tension.

The process according to the present invention is based on the above discovery. More specifically the present invention provides a process for producing a liquid crystal display device comprising Smectic liquid crystal material, comprising:
providing an LC panel comprising a pair of substrates, and
filling the space between the pair of substrates with a Smectic liquid crystal material, while adjusting the liquid crystal molecular primary axis along with the pre-set or pre-designed alignment direction, and while adjusting the liquid crystal moving direction in the space between the pair of substrates at the filling of the Smectic liquid crystal material along with the pre-set alignment direction.

In the present invention, the concept thereof may for example include following items:

(a) Adjust LC material's anisotropy as an elastic material with the pre-set LC molecular alignment direction as well as LC filling or spreading direction in an LC panel.

(b) In order to avoid anonymous Marangoni flow due to surface tension, proper amount of pressure is applied from outside the panel during the LC filling process.

(c) Each of the above items (a) and (b) is effective to accomplish the purpose of this Invention. However, the combination of (a) and (b) provides the maximum effect in terms of the accomplishment of the purpose of the invention.

(d) Some auxiliary means to pursue the Invention may be used, as desired

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a schematic sectional view showing a relationship between filling stage and surface tension. FIG. 1 shows each filling stage and stage dependent of surface tension power.

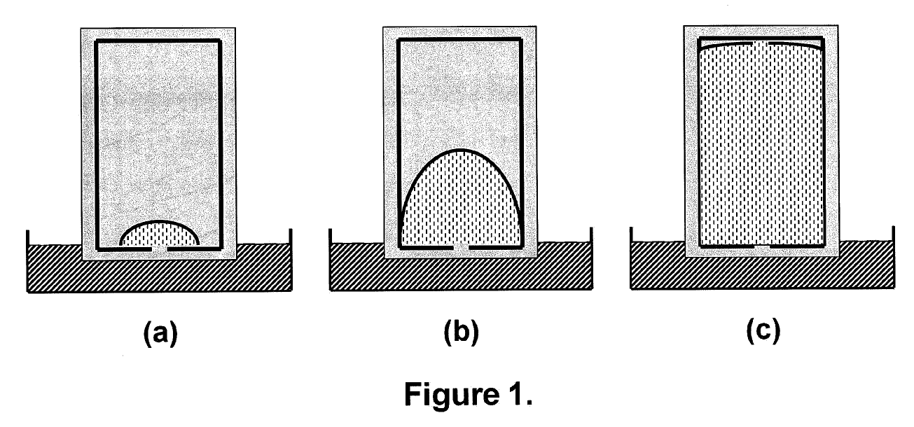

FIG. 2 is a schematic sectional view showing an orientational order of Nematic LC molecules. FIG. 1 shows orientational order of Nematic liquid crystal molecules and their mass center.

FIG. 3 is a schematic sectional view showing orientational and translational order of Smectic LC molecules. FIG. shows both Orientational order and Translational order of Smectic liquid crystal molecules and their mass center.

FIG. 4 is a schematic sectional view showing Smectic A phase molecular axis and its layer. FIG. shows that Smectic A phase liquid crystal molecular axis is normal to its layer.

FIG. 5 is a schematic sectional view showing Smectic C phase molecular axis and tilt angle. FIG. shows that Smectic C phase liquid crystal molecular axis has some tilt angle to the normal to its layer.

FIG. 6 is a schematic sectional view showing an example of LC filling direction of Smectic C phase. FIG. 6(a) shows LC filling case of Smectic A phase, and FIG. 6(a) shows LC filling case of Smectic A phase.

FIG. 7 is schematic sectional and plan view showing an example of wide spreading of LC material under large area external pressure. FIG. 7 shows wide spreading of liquid crystal material with large area external pressure.

FIG. 8 is schematic sectional and plan view showing an example of spreading of LC material under local line pressure. FIG. 8 shows local line pressure of liquid crystal material.

FIG. 9 is schematic plan view showing an example of spreading of dropped LC material in the case of vertical lamination. FIG. 9 shows that vertical lamination causes isotropic spreading of dropped liquid crystal material on the substrate.

FIG. 10 is schematic sectional view showing an example of spreading of droplets of LC material in the case of wedge shape lamination. FIG. 10 shows that wedge shape lamination gives specific direction to spreading liquid crystal droplets.

FIG. 11 is schematic sectional view showing an example of optical system for detecting liquid crystal front line. FIG. 11 shows optical detection of liquid crystal front line.

FIG. 12 is schematic perspective view showing a device system for practicing an embodiment of the present invention. FIG. 12 shows one examples of the system of this invention.

FIG. 13 is schematic sectional view for illustrating total panel capacitance of a panel during LC filling. FIG. 13 shows total panel capacitance of a panel during LC filling.

FIG. 14 is a graph showing an example of total panel capacitance depending on LC filling time. FIG. 14 shows Total panel capacitance depending on LC filling time.

FIG. 15 is a graph showing another example of total panel capacitance depending on LC filling time. FIG. 15 shows Total panel capacitance depending on LC filling time.

### DETAILED DESCRIPTION OF PREFERRED EMBODIMENTS

Hereinbelow, the present invention will be described in detail with reference to the accompanying drawings, as desired. In the following description, “%” and “part(s)” representing a quantitative proportion or ratio are those based on mass, unless otherwise noted specifically.

Theoretical Background

There are two major factors must be solved to accomplish this Invention. The first factor is specific arrangement of anisotropy of liquid crystal materials. The second factor is specific control of surface tension during liquid crystal filling in a panel. These two factors are independently applied to accomplish this Invention, however, these two factors have synergy effects each other to enhance the effect of the Invention.

The Arrangement of Anisotropy of Liquid Crystal Materials

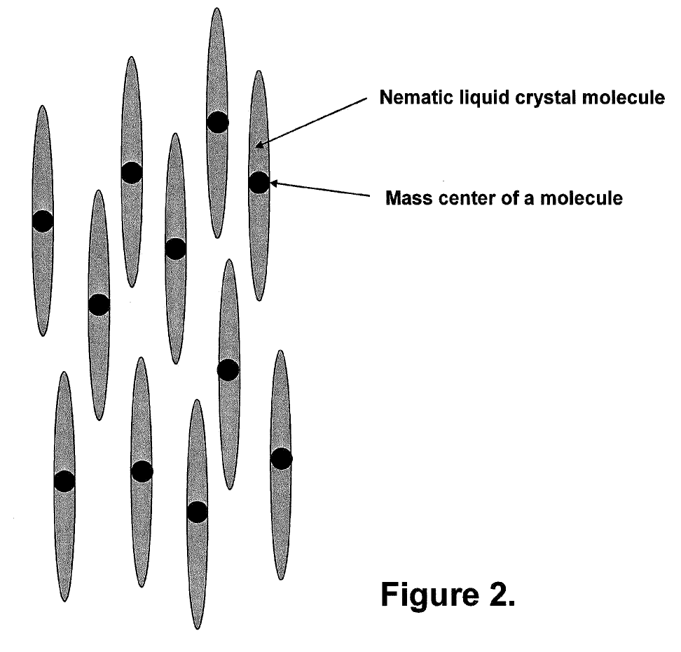

Liquid crystal material has certain anisotropy in general. How strongly each liquid crystal material has anisotropy is dependent on its classification of a liquid crystal phase. Most of conventional LCDs use Nematic phase liquid crystal materials. Nematic phase liquid crystal materials have orientational order as shown in FIG. 2. Orientational order limits each liquid crystal molecule to align a certain direction only. Therefore orientational order gives rise to each liquid crystal molecular axis same direction.

However, the mass-center of each liquid crystal molecule has no particular order. This means that orientational ordered liquid crystal material has crystal-like order only for the given direction of orientational order. Nematic phase liquid crystal molecules have this type of orientational order. Therefore, it is approved to say that Nematic phase liquid crystal materials show crystal-like order only for the orientational ordered direction, and other directions show isotropic liquid properties. On the other hand, Smectic phase liquid crystal materials have a little more ordered structures, or another ward, they have more “crystal-like” order than that of Nematic phase liquid crystal materials.

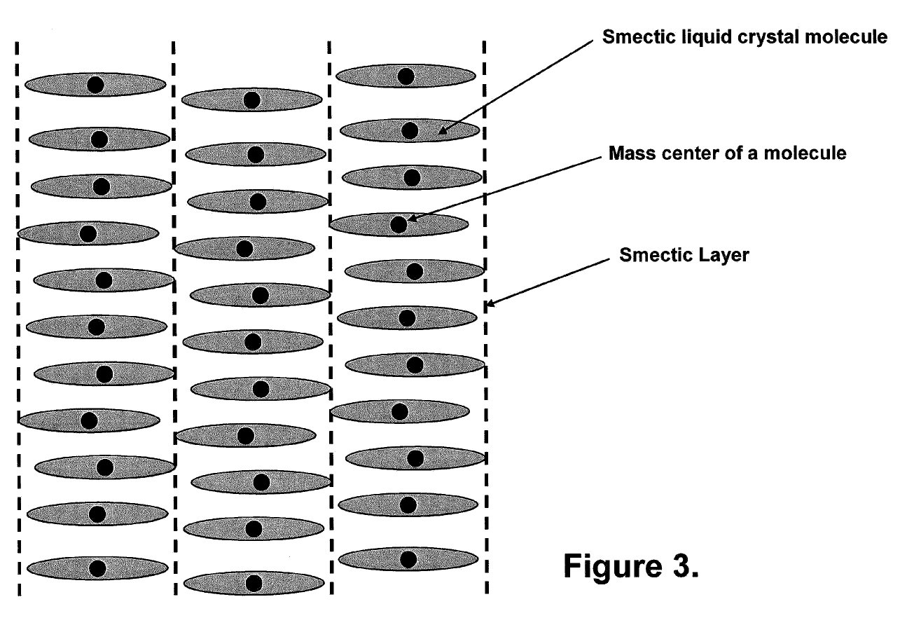

FIG. 3 illustrates Smectic phase liquid crystal materials order configuration. Smectic phase liquid crystal materials have orientational order same with Nematic phase liquid crystal materials. Smectic phase liquid crystal materials also have the translational order as shown in FIG. 3. The translational order is just like a repeating structuring order. Each Smectic layer structure is only allowed behaving as a unit of each layer, not each liquid crystal molecule.

Although each Smectic liquid crystal molecule is allowed moving inside the same layer, and not allowed inter-layer movement, each Smectic liquid crystal molecule has relatively free movement inside the Smectic layer structure just illustrated in FIG. 3. Therefore, Smectic phase liquid crystal molecule behaves just like Nematic phase liquid crystal molecule just in a Smectic layer, but each Smectic liquid crystal molecule is strictly restricted its movement just inside a single Smectic layer only, and never allowed moving out to neighboring Smectic layer. In this point of view, it may be allowed to say that Smectic phase liquid crystal materials have “crystal-like” structure both in x, and y axis, however, in z-axis, they remain isotropic nature or simply saying “liquid-like” properties. In the same type of expression, Nematic phase liquid crystal materials have “liquid-like” structure in x, and y axis, in z-axis, they have orientational restriction.

Above discussion regarding difference of order parameters between Nematic phase and Smectic phase liquid crystal materials clarifies difference in allowable freedom in molecular movement in each liquid crystal phase. In straightforwardly speaking, Nematic phase liquid crystal materials can move two dimensionally without specific restriction, and can move one direction with restriction in one dimensionally. On the other hand, Smectic phase liquid crystal materials can move only one dimensionally without any specific restriction, but have significant restriction in other two dimensions.

Moreover, Smectic phase liquid crystal materials have some virtual layer structure shown in FIG. 3. Due to strict restriction in its molecular movement, the concept of a Smectic layer structure has been introduced to describe molecular behavior of Smectic phase liquid crystal molecules. This Smectic layer structure has specific relationship with molecular alignment of each Smectic phase liquid crystal molecule from its nature of introduction. As illustrated in FIG. 3, when a Smectic liquid crystal molecule aligns a certain direction as shown in FIG. 3, the Smectic layer is formed in a certain direction.

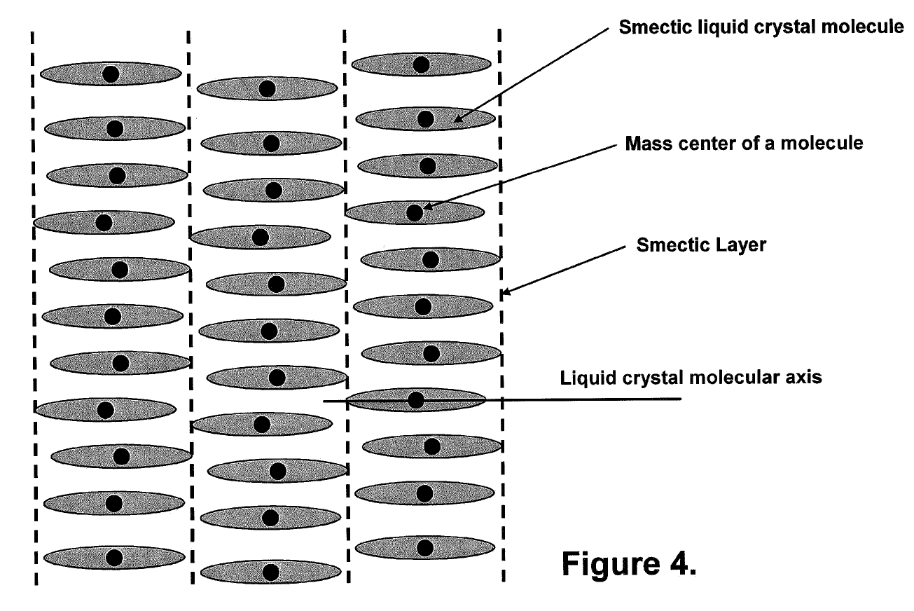

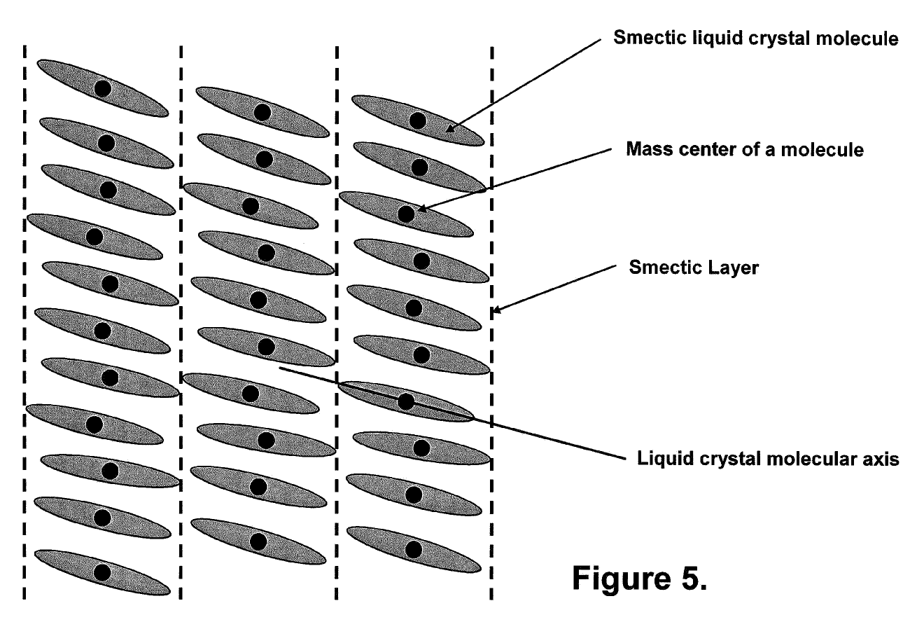

When we discuss Smectic A and B phase liquid crystal materials, the Smectic layer structure must be formed perpendicular to the Smectic A liquid crystal molecular axis as shown in FIG. 4. When we discuss Smectic C phase liquid crystal materials, the Smectic layer structure must be formed with some certain tilt angle from Smectic C phase liquid crystal molecular axis as shown in FIG. 5.

Unlike Nematic liquid crystal materials, Smectic liquid crystal materials show more “crystal-like” behavior in their molecular movement. Therefore, when Smectic liquid crystal materials are moving into an LC panel, if the invasion direction of the liquid crystal materials in an LC panel does not fit with allowable molecular moving direction in terms of “crystal-like” order parameter of Smectic phase liquid crystals, the movement of Smectic liquid crystal materials is very difficult to hold the Smectic order, resulting in too much stress at the surface of alignment layer. This tendency is applicable to isotropic phase of Smectic liquid crystal materials.

Regardless bulk phase condition, at the interface between the top surface of alignment layer and liquid crystal molecules, this particular interfacial area show Smectic liquid crystal order in terms of inter-molecular interaction. Therefore, it is extremely important to reserve well enough free energy to each higher ordered liquid crystal molecule behaving “two dimensional crystal” during LC filling process. If the free energy is not enough during the LC filling process, the liquid crystal material is hard to keep well ordered Smectic layer structure, resulting in non-uniform molecular alignment. This situation is still preserved even the LC filling process is at isotropic phase temperature.

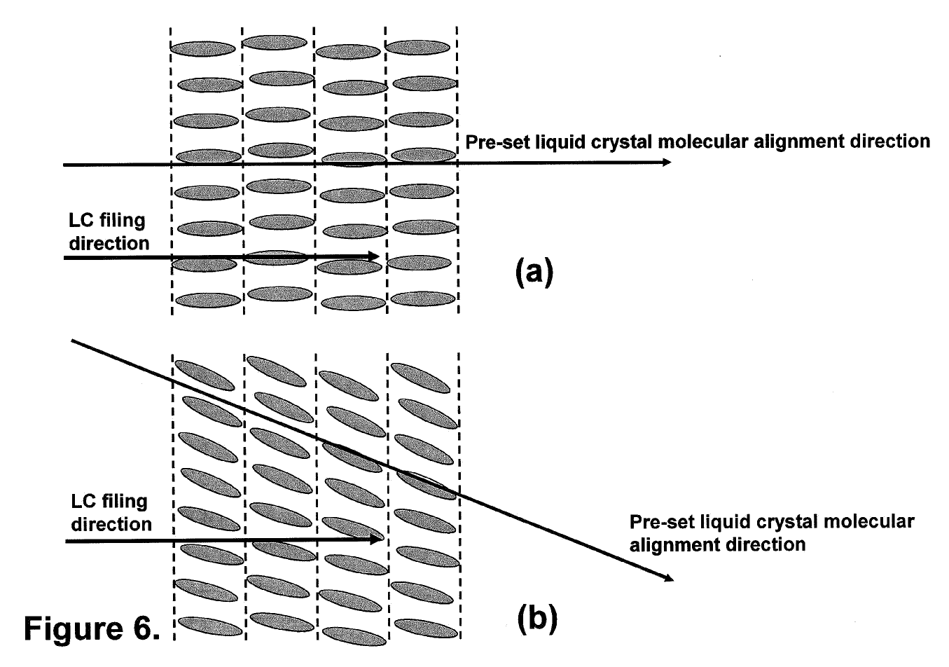

Since, the interface between the top surface of alignment layer and liquid crystal molecule regardless its phase, there works surface interaction such as surface tension. This surface interaction makes specific state other than liquid phase, nor crystal phase. The control of interaction at the interface between the top surface of alignment layer and liquid crystal molecule is essential to keep uniform molecular alignment as well as uniform forming of Smectic liquid crystal layer. The Inventors found that this surface interaction is well enough controllable by adjusting the pre-setting liquid crystal molecular alignment direction and the forming direction of liquid crystals' layer structure from above discussed theoretical consideration as well as empirical confirmation of this theory. The major point of this theory is illustrated in FIG. 6.

As illustrated in FIG. 6(a), when a Smectic liquid crystal molecule whose Smectic layer is normal to its molecular axis is filled to an LC panel, the pre-set liquid crystal molecular alignment direction must be parallel to the liquid crystal molecular moving direction. This is the case of Smectic A phase, Smectic B phase and so on. When a Smectic liquid crystal molecule whose Smectic layer has some tilt angle to the liquid crystal molecular axis, the pre-set molecular alignment direction must be adjusted to the tilt angle direction as illustrated in FIG. 6(b). It is known that some specific case of Smectic liquid crystal display modes, such as PSS-LCD (US published patent application: 20040196428), even bulk Smectic liquid crystal material has some tilt angle from its Smectic layer normal, this type of Smectic liquid crystal molecule aligns almost parallel to the pre-set alignment direction. This case should be treated as Smectic A phase liquid crystal molecule as described above.

The concept of arrangement between pre-set liquid crystal molecular alignment direction and formation of layer structure is based on very basic idea of elastic materials nature. Since liquid crystal material is described as an elastic material in phenomenological manner.

There are several classifications to discuss elastic materials. When Nematic liquid crystal material is discussed, its molecular axis has some flexibility in terms of the direction of tensile of materials distortion. This flexibility in Nematic liquid crystal is much larger than that of Smectic liquid crystal material due to above described difference in order parameter. In nematic liquid crystal, when some tensile is applied which is always applied more of less at liquid crystal filling process regardless filling process method, Nematic liquid crystal molecule has some flexibility in terms of mutual direction of tensile and liquid crystal molecular axis as an elastic material. This adjustability is helpful to avoid giving too much stress to the top surface of alignment layer. However, less flexibility in Smectic liquid crystal material gives much higher opportunity to give some stress on the top surface of alignment layer.

Because, in Smectic liquid crystal material, it is relatively difficult to adjust its molecular axis as an elastic material from the direction of applied tensile. This difference in elastic material characteristic is the major difference in Nematic liquid crystal material and Smectic liquid crystal material.

The specific control of surface tension As an elastic material, there are two types of materials in general. One is so-called “Newton-type” or “Stokes-type”, the other one is “Non-Newton-type”. (Reference: Chapter 5 “Elastic Liquid” A. S. Lodge, Academic Press, London, in 1964) Newton-type liquid keeps its viscosity constant regardless applied tensile force. On the other hand, Non-Newton-type liquid changes its viscosity depending on externally applied tensile power. In general liquid crystal material shows both Newton-type and Non-Newton-type characteristics.

As a bulk material, liquid crystal material would be expected to be Newton-type. However, at the interface, or in a domain wall area, liquid crystal material shows significant Non-Newton-type characteristics. This some sort of “two-face” characteristics of liquid crystal material introduces somehow complicated phenomenon, in particular at the interface between alignment layer and liquid crystal molecules. When liquid crystal material is facing at the top surface of alignment layer, regardless liquid crystal filling process, at the interface between the top surface of alignment layer and liquid crystal material, the liquid crystal shows Non-Newton-type characteristics.

On the other hand, bulk area of liquid crystal material still keeps Newton-type characteristics. This “two-face” characteristics of liquid crystal material is provided by specific interaction between the top surface of alignment later and liquid crystal material. In the other word, this unique phenomenon is provided by specific surface tension effect.

Based upon above well known phenomena, the Inventors investigated each cases of surface tension situation with Nematic liquid crystal, Chiral Nematic liquid crystal, and Smectic liquid crystal. As discussed at previous section, in nematic liquid crystal case, due to relatively flexible characteristics in terms of elastic material, the difference in Non-Newton-type and Newton-type, or Surface tension area and bulk area is relatively small.

This means, the influence from surface tension into the bulk characteristics of liquid crystal material is relatively small. On this case, when liquid crystal material comes into liquid crystal panel, it is relatively easy to keep some sort of balance between surface tension power and bulk elastic material's characteristics.

In this case, the flow of liquid crystal material shows constant Marangoni flow. (Reference: “Oscillatory Thermocapillary Convection of Half-Zone Liquid Bridge with Consideration of Ambient Air Motion and Heat Transfer”: M. Harashima, S. Kawame, and H. Kawamura, Thermal Science & Engineering, Vol. 15, No. 3, pp. 119-pp. 127 (2007) in Japanese) As long as Marangoni flow is showing constant, there is no particular separation in liquid crystal material. However, if Marangoni flow shows some sort of anonymous flow, the interface area and bulk area of liquid crystal material show some separation in terms of elastic material, result in liquid crystal internal separation.

This separation sometimes provides local extremely strong power, resulting in change of surface pre-tilt angel, and even change of molecular alignment direction. Since anonymous Marangoni flow is accompanied with some specific heat flow, this change of heat flow also provides some local change of liquid crystal molecular alignment. This anonymous Marangoni flow has some tendency of enhancement with more anisotropic elastic material. Therefore, compared to Nematic liquid crystal material, Smectic liquid crystal material shows higher tendency to have anonymous Marangoni flow than that of Nematic liquid crystal material.

Based on above theoretical consideration, the Inventors investigated possible practical suppression of anonymous Marangoni flow at the liquid crystal filling process. As the result of Inventors investigation, it was found that the anonymous Marangoni flow happens at the surface tension is extremely strong, and this strong surface tension has strong influence to bulk area of liquid crystal material. Therefore, in order to suppress anonymous Marangoni flow at the liquid crystal filling process, it should be effective to suppress surface tension power. However, in general, surface tension is decided by materials those meet each other. Therefore, the Inventors considered suppressing surface tension. One of the examples of practical and effective suppression of surface tension is application of external pressure at the front range of liquid crystal spreading to liquid crystal panel.

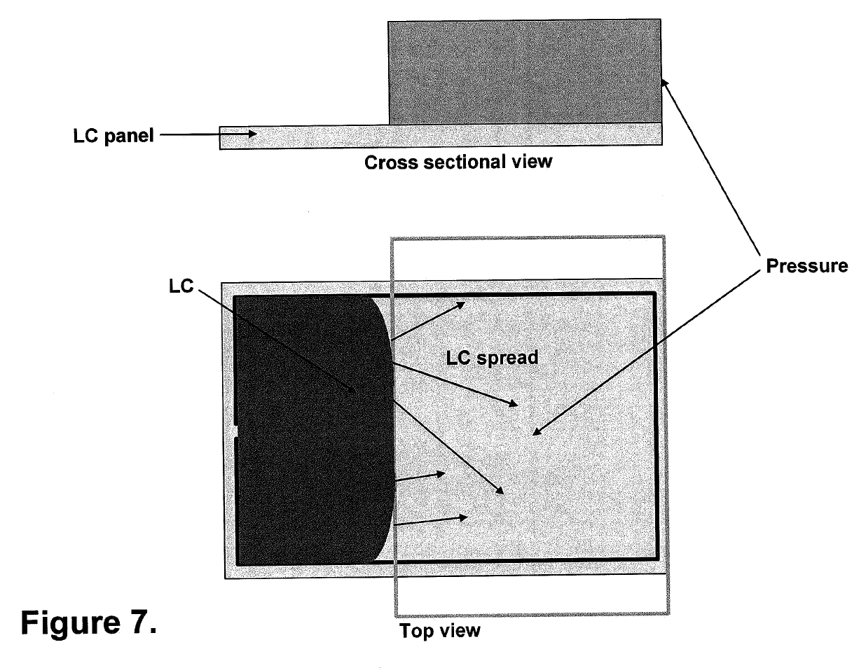

The concept of this means is to cancel surface tension power by giving suppression power to only the front range of liquid crystal spreading. It is extremely important to apply well enough pressure from outside liquid crystal panel to just the front range of liquid crystal spreading. If the pressure power is applied to too much wider area, the pressure creates unnecessary stress to the liquid crystal material following to the front range of liquid crystal material, resulting in disturbance of liquid crystal alignment direction as illustrated in FIG. 7. As long as the external pressure is applied just at the front line area of liquid crystal material, this external pressure effectively cancels local surface tension power, resulting in prevention from anonymous Marangoni flow.

Synergy Effects with Practical Method of this Invention

Above two factors described are essential to have uniform liquid crystal molecular alignment as well as uniform panel gap in LCD volume manufacturing. In order to have uniform enough panel gap without having unevenness in liquid crystal molecular alignment and obtaining high enough manufacturing throughput in volume LCD manufacturing, both controls in anisotropy of liquid crystal molecules and constant Marangoni flow are necessary. Each factor, namely control of anisotropy of liquid crystal molecule or constant Marangoni flow is intrinsic factor. However, in practical manner to accomplish the purpose of this Invention, it is extremely effective to combine these two factors with some specific balance of use.

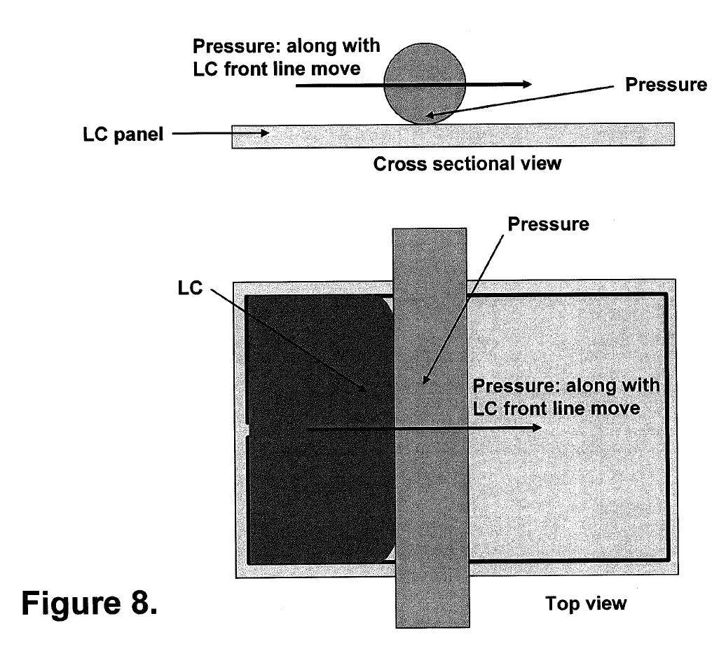

First of all, the liquid crystal anisotropy must be considered in terms of adjustment with the pre-set liquid crystal molecular alignment direction such as shown in FIG. 6. In second, some proper amount of external pressure should be applied to the liquid crystal panel with synchronized liquid crystal materials invasion to the panel. The pressure point or line from outside the panel must be well synchronized the liquid crystal invasion rate to the panel. According to the moving line of the liquid crystal front line, the pressure line must be adjusted to the line as illustrated in FIG. 8.

Practical Means to Accomplish this Invention

Determination of LC Filling Direction

As described in general, one of the intrinsic requirements of the Invention is to adjust LC filling direction to the pre-set LC molecular alignment direction as Shown in FIGS. 6 and 8. This particular requirement is commonly applied regardless LC filling methods such as the Pressure Difference Method, ODF Method. At the Pressure Difference Method, this requirement is straightforwardly applied. As illustrated in FIGS. 6 and 8, depending on relative liquid crystal molecular axis to its Smectic layer, the pre-set liquid crystal molecular alignment direction must be adjusted to the molecular axis direction.

In case of Smectic C phase, Smectic H phase and so on whose Smectic layer has some tilt angle with its liquid crystal molecular axis, its tilt angle is dependent on ambient temperature. In this case, the adjusted liquid crystal filling direction should be set at the tilt angle at room temperature. More precisely speaking, the molecular filling direction should be set for the most stable molecular tilt angle from Smectic Layer normal. The reason why the set liquid crystal filling angle should be adjusted to the most stable tile angle is following. The tilt angle of Smectic liquid crystal from its layer normal is quite essential characteristic property.

Most of this type of Smectic liquid crystal mixture in commercially acceptable one is designed to have the maximum tilt angle at room temperature. Here, the maximum tilt angle means 45 degrees to obtain the maximum light throughput at usual birefringence mode. In case of Surface Stabilized Ferroelectric Liquid Crystal (SSFLC) display mode, the maximum tilt angle to provide the maximum light throughput is 22.5 degrees. In any cases, the intrinsic requirement is to set liquid crystal filling direction should be adjusted to the maximum angle for the LCD provides the maximum light throughput. This type of molecular tilt angle is dependent on molecular packing configuration in a single Smectic layer.

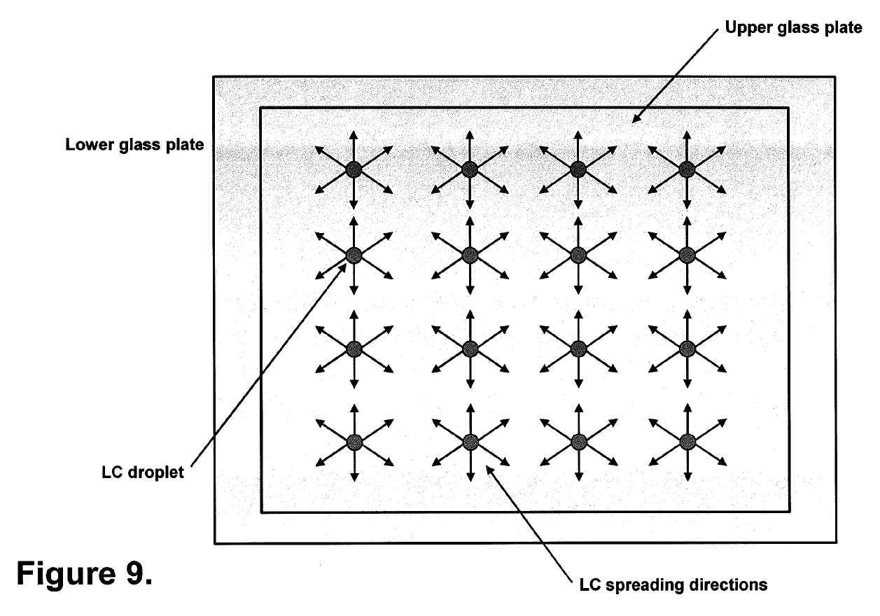

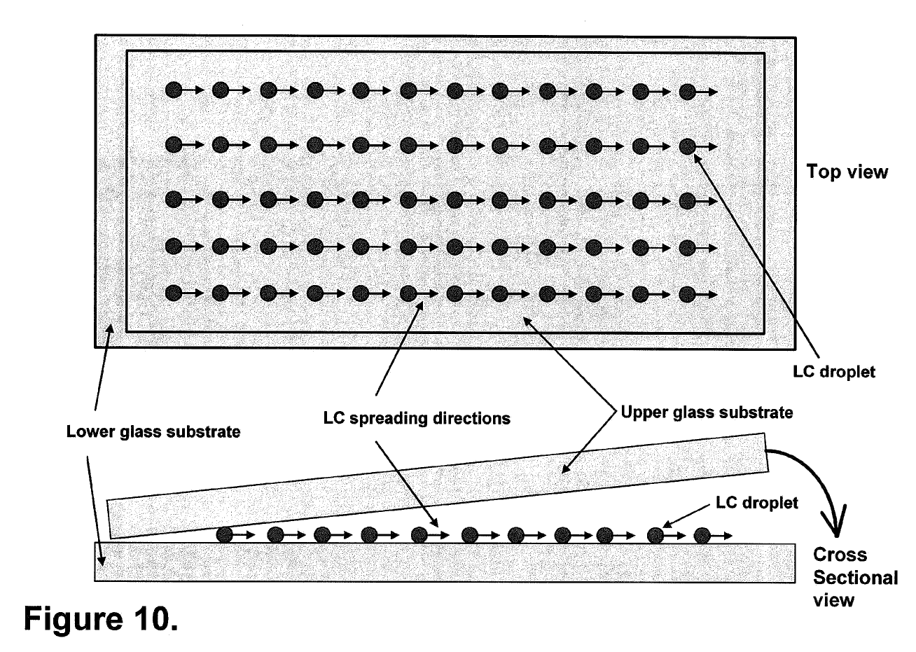

Therefore, adjusting LC filling direction to the maximum molecular axis tilt angle is equivalent to stabilize the Smectic layer structure. Stabilization of Smectic layer structure leads to minimizing liquid crystal internal stress in terms of anisotropic elastmer material as described at “The arrangement of anisotropy of liquid crystal materials”. At an ODF Method, simple lamination method needs a little modification in order to clarify liquid crystal spreading direction during the lamination method. At the conventional lamination method in an ODF Method, the lamination is used vertically, resulting in isotropic spreading of dropped liquid crystal material in the panel as illustrated in FIG. 9. As described at “The arrangement of anisotropy of liquid crystal materials”, liquid crystal droplet must be spreading to a set single direction, not to multiple different directions. Therefore, at an ODF Method is deployed, the lamination of the upper glass substrate to the lower substrate must be laminated with some tilt angle, or just like wedge shaped lamination as illustrated in FIG. 10. This wedged lamination gives dropped liquid crystal material to move out to the single direction. This spreading direction must be adjusted to the pre-set liquid crystal molecular moving direction.

3.3.2. Pressure Detecting and Determination to Avoid Anonymous Marangoni Flow

As described at section “The specific control of surface tension”, externally applied pressure to avoid anonymous Marangoni flow is also essential to accomplish this Invention. Here the pressure determination and detecting methods are discussed. The purpose of applied specific pressure is to avoid anonymous Marangoni flow, therefore, the actual requirement is not to decide precise pressure, but to decide liquid crystal flow rate constant in an LC panel regardless Pressure Difference Method, nor ODF Method. Since, viscosity of liquid crystal material has some variation, therefore, in order to practice this Invention, the most intrinsic requirement is to give LC filling front line constant spreading flow. There are several methods to fulfill this requirement. Followings are some example to control LC flow constant, and to avoid any anonymous Marangoni flow in an LC panel.

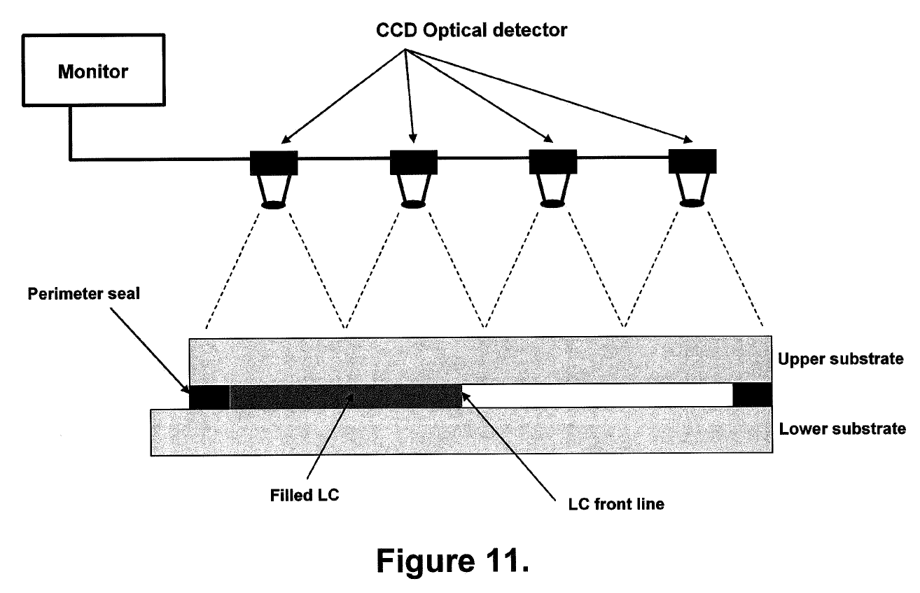

There are two major ways as a concept to determine proper applied pressure. One is detecting panel gap on line, the other is to detect LC filling front line rate optically. The former is to measure electrostatic capacitance of the panel on line during liquid crystal filling. FIG. 11 explains this method schematically. At an liquid crystal filling process, once anonymous Marangoni flow happens, due to local extreme surface tension, panel gap changes relatively largely. This change of panel gap is easily detectable by electrostatic capacitance change dependent on following equation.

$$d = {ɛɛ}_{0} \frac{S}{C}$$

Here, d is panel gap, S is area covered by electrodes, C is electrostatic capacitance of the panel, ε is specific dielectric constant of liquid crystal material, and ε₀ is dielectric constant of vacuum. Using above equation, relatively small panel gap change is detectable. For instance, when the panel overall size is 40″, S is approximately 4,400 cm2. A typical specific dielectric constant of liquid crystal material is 10. Also a typical panel gap is 4 micron. Therefore using vacuum dielectric constant value, total electrostatic capacity of the panel is about 9.7 μF.

Suppose that when a quarter of the 40″ panel is filled with the liquid crystal material having ε of 10 of LC material, the total panel electrostatic capacitance is approximately 7.5 μF with LC empty area with air capacity. Using a typical LCR meter such as Agilent Precision LCR Meter, its detective limit of electrostatic capacitance is about pico Farad. Therefore change of panel gap during LC filling with 0.01 μm, is well enough detective by measuring electrostatic capacitance. As long as using same size of LC panel with same liquid crystal material, the panel total capacitance is same, therefore, once this measurement is confirmed, power of externally applied pressure and its control is pre-set to the volume filling process system.

The other method is to measure moving rate of LC filling front line by optical means. Once liquid crystal material is filled, the area is filled with higher reflective index material. Using the difference in reflective index between liquid crystal and air, light transmittance is measured at LC filling area. By detecting light throughput, its moving rate, namely velocity of LC front line is measurable. When anonymous Marangoni flow happens, this velocity of LC front line shows significant change. Once this change is detected, the externally applied pressure is increased, and suppresses the anonymous Marangoni flow.

Actual power of pressure to suppress anonymous Marangoni flow is totally up to the panel size, power of surface tension, and even panel aspect ratio. Roughly speaking, it is required 0.3 to 1.5 kg/cm2. However, this power is just averaged requirement, and it is again, totally dependent on specific case.

Hereinbelow, the present invention will be described in more detail with reference to specific Examples.

### EXAMPLES

### Example 1

This Invention

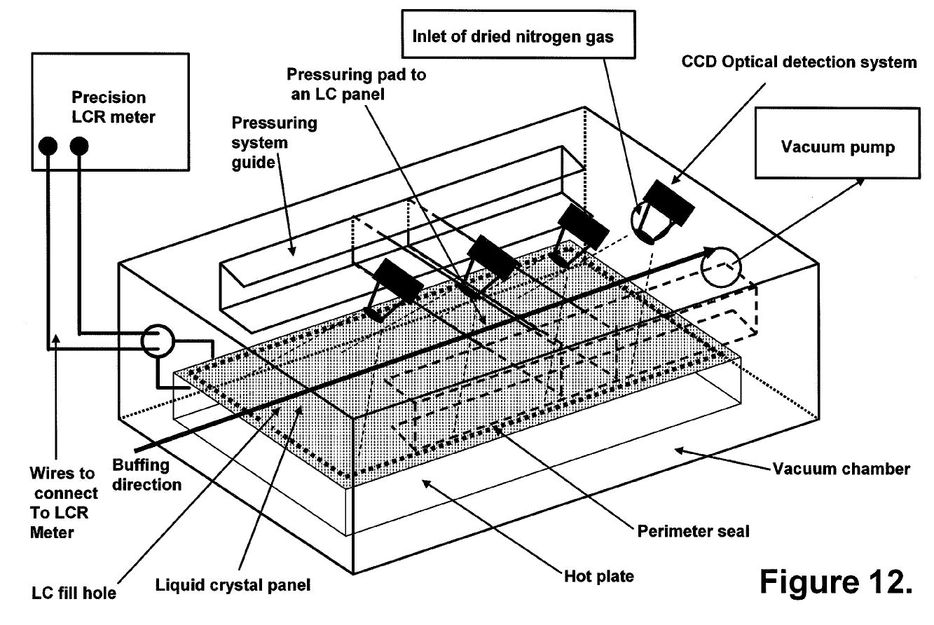

10-inch with 4:3 aspect ratio panel is prepared using single transparent electrode glass substrate. Whole area of the glass substrate is covered with 1,500 A thickness with 10 Ω/square centimeters of resistivity of transparent electrode film made of ITO. The surface of the ITO is covered with pre-imidized polyimide. After coated the poly-imide by spin coating, the poly-imide layer is baked at 180 degrees C., one hour. The finished poly-imide layer thickness is 500 A. After cured poly-imide, the surface of the poly-imide is mechanically buffed by a buffing machine. The direction of the buffing is along with longitude of the substrate as shown in FIG. 12.

Preparing a pair of the same poly-imide coated glass substrates, using 2 μm diameter silicon dioxide particles are splayed on the surface of one of the substrate. Using epoxy resin glue material, very perimeter area of the glass substrate is coated and laminated. The obtained empty panel has well enough uniformity within ±0.2 μm of panel gap variation. This panel is set in a vacuum chamber. A hot plate is placed in the vacuum chamber, and the empty panel is put on the hot plate in the chamber. Two wires connected to each substrate electrode are connected to the Precision LCR Meter through vacuum sealed terminal as shown in FIG. 12. Also a photo detector made of CCD sensor is set at three positions to detect the front line of LC material invasion to the empty panel as shown in FIG. 12.

Also a line-type of mechanical pressuring system having its width of mechanical pressure on the LC panel with 10 mm is set being held by two guide rails equipped at the internal wall of the chamber as illustrated in FIG. 12. This line-type mechanical pressuring system moves along with LC filling direction as shown in FIG. 12. A PSS-LC mixture prepared by home formulation is put near to the fill hole on the empty panel as shown in FIG. 12. The PSS-LC material aligns along with mechanical buffing direction. Therefore, its liquid crystal molecular axis is perpendicular to its Smectic Layer. First, the chamber is sack up air by a dry pomp.

The vacuum level is set at 10-2 Torr. After kept 10-2 Torr half hour, then, hot plate temperature is set at 95 degrees C. The PSS-LC material which is a part of Smectic liquid crystal, melts to isotropic liquid at 92 degrees C, and the isotropic liquid covered with the fill hole. Then, vacuum level is gradually released to back to normal atmosphere by introducing dried nitrogen gas into the chamber.

As soon as the nitrogen gas is introduced into the chamber, LC front line is formed as illustrated in FIG. 12. The front line is detected its moving rate (namely velocity) by set CCD detectors. In this condition, the LC front line moves about 12 mm/min up to about one third of distance from fill hole side. In next one third, average LC front line movement has about 6 mm/min rate, and then the last one third, its averaged rate is about 3 mm/min. Total of 37 min required to fill whole area of the empty panel. During the LC filling process, at the first one third of distance from the fill hole side of edge, the mechanical pressure applies 0.5 kg/cm2, then next one third, 0.9 Kg/cm2 is applied.

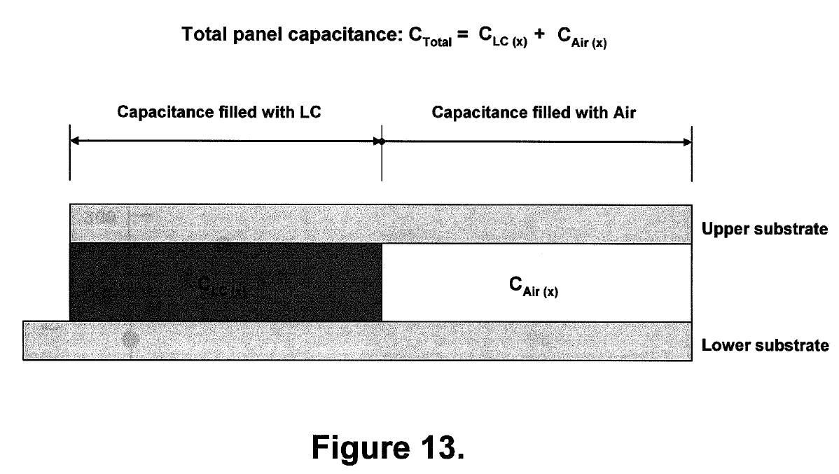

Finally the last one third, 1.3 Kg/cm2 is applied. Under these mechanical pressuring condition, the panel total electrostatic capacitance shows almost linear change taking account into the capacitance difference between liquid crystal material and air. Since the capacitance is parallel coupling between liquid crystal filled area and air filled area, respectively. When the liquid crystal filled area has capacitance of CLC(x), air filled (or empty area) area has capacitance of CAir(x), respectively, total capacitance of the panel is CLC(x)+CAir(x). Here, x represents the distance of the LC front line from the fill hole edge as shown in FIG. 13.

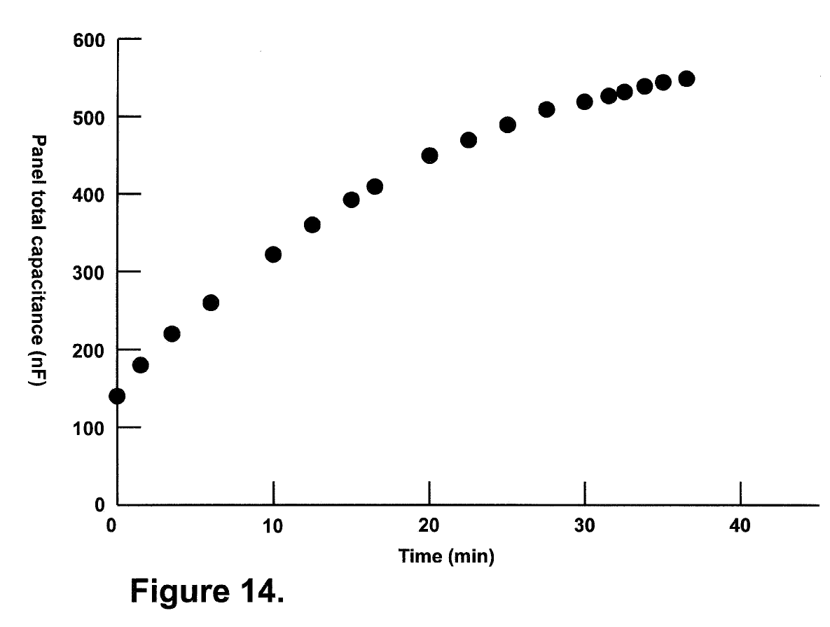

Therefore, if the liquid crystal front line moves constantly, which means no anonymous Marangoni flow, the panel gap filled with LC must be no particular change from the pre-set or designed panel gap. Here, the LC front line move is taken account into spread of volume with moving into deep area of the LC panel. Therefore, the obtained measured result shown in FIG. 14 shows almost constant profile in terms of capacitance change that suggests no anonymous Marangoni flow. After whole area of the empty panel is filled with the LC material, uniformity of the LC molecular alignment is observed. The observed unevenness in terms of light throughput is within variation of ±3%, therefore this panel has well enough uniformity.

### Example 2

Control

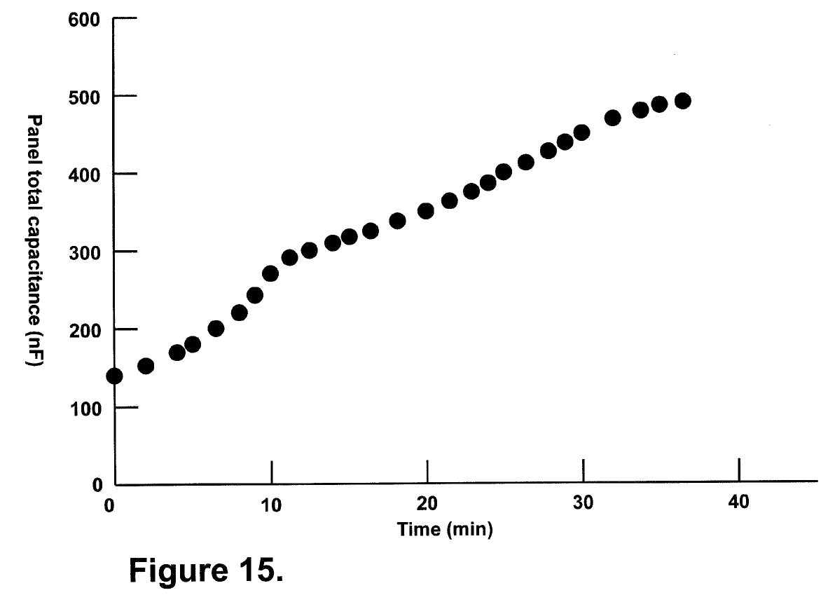

Using same size of panel and same liquid crystal material with the above Invention of example, simply, no mechanical pressure is applied during liquid crystal filling. Other than absence of mechanical pressure, everything is applied as same as the example mentioned above Invention. The measured capacitance change result depending on filling time is shown in FIG. 15. FIG. 15 suggests that the filling process is not going with constant manner, but has some stepwise LC front line. This no constant LC front line movement suggests significant panel gap changes occasionally happened during the filling process. The obtained LC filled panel here shows smaller total capacitance compared to the Invention in previous example.

This small total panel capacitance suggests the Control example panel has larger panel gap than that in the Invention panel. Also, the time dependence profile in capacitance change has some non-continuous change. This profile strongly indicates occasional existence of anonymous Marangoni flow at each non-continuous change of panel capacitance. In this particular LC filling condition, the LC front line moves about 16 mm/min up to about one third of distance from the fill hole side. In next one third, average LC front line movement has about 9 mm/min rate, and then the last one third, its average rate is about 4 mm/min. Total of 30 min required to fill whole area of the empty panel. After whole area of the empty panel is filled with the LC material, uniformity of the LC molecular alignment is observed. There is some unevenness in terms of light throughput with maximum variation of ±38% is observed.

### Example 3

This Invention with Different Means

2.1-inch with 4:3 aspect ratio panel is prepared using single transparent electrode glass substrate. Whole area of the glass substrate is covered with 1,500 A thickness with 10 Ω/square centimeters of resistivity of transparent electrode film made of ITO. The surface of the ITO is covered with pre-imidized polyimide. After coated the poly-imide by spin coating, the poly-imide layer is baked at 180 degrees C., one hour. The finished poly-imide layer thickness is 500 A. After cured poly-imide, the surface of the poly-imide is mechanically buffed by a buffing machine. The direction of the buffing is along with longitude of the substrate as same as in FIG. 12.

Preparing a pair of the same poly-imide coated glass substrates, using 2 μm diameter silicon dioxide particles are splayed on the surface of one of the substrate. Using epoxy resin glue material, very perimeter area of the glass substrate is coated and laminated. The obtained empty panel has well enough uniformity within ±0.15 μm of panel gap variation. This panel is set in a vacuum bag made of poly-ethylene. When the empty panel is put into the vacuum bag, the same PSS-LC material used at 4.1 is placed near to the fill hole. Using vacuum sealant machine, inside the vacuum bag is sack up air, and the open side of the bag is sealed in the vacuum sealant machine keeping vacuum condition.

After the vacuum bag is sealed, and then the bag is placed on the hot plate. The hot plate is elevated its temperature to 95 degrees C. under normal atmosphere. Keeping the elevated temperature condition half hour, and then, the hot plate temperature is reduced at the rate of 3 degrees C. per minute to 40 Degrees C. After the panel temperature comes down near to room temperature, the vacuum bag is open and the transmittance variation is measured. The variation of transmittance in 9 points in the panel shows variation within ±2%. This variation is well enough in terms of uniformity of the screen luminance.

### Example 4

Control

The same sized 2.1-inch with 4:3 aspect ratio panel is prepared using same preparation with above 4.3. The 2.1″ panel is prepared same way until the empty panel is finished. Then, the same PSS-LC material used at 4.3 is placed near to the fill hole. This panel is placed on the hot plate without using any vacuum bag. The hot plate is elevated its temperature to 95 degrees C. under normal atmosphere. Keeping the elevated temperature condition half hour, and then, the hot plate temperature is reduced at the rate of 3 degrees C. per minute to 40 Degrees C. After the panel temperature comes down near to room temperature, the transmittance variation of the panel is measured. The variation of transmittance in 9 points in the panel shows variation within ±27%. This variation is fur larger than the acceptable level as an actual product.

Impact of this Invention

Based upon fundamental investigation of LC filling process in conjunction with anisotropic nature of liquid crystal material as well as surface tension characteristics in particular suppression of anonymous Marangoni flow provides practical and effective means for most of liquid crystal filling process. Applying this Invention, most of liquid crystal filling process regardless Pressure Difference Method, or ODF Method, is able to keep uniform liquid crystal molecular alignment with constant panel gap during LC filling process, and the constant panel gap during LC filling process provides uniform enough liquid crystal molecular alignment with keeping high enough throughput in filling process matching with requirement of high volume production. In particular, this Invention provides practical solution in volume manufacturing to Smectic and higher viscosity type of LC material devices.

From the invention thus described, it will be obvious that the invention may be varied in many ways. Such variations are not to be regarded as a departure from the spirit and scope of the invention, and all such modifications as would be obvious to one skilled in the art are intended to be included within the scope of the following claims.

What is claimed is:

1. A process for producing a liquid crystal display device comprising Smectic liquid crystal material, comprising:
providing an LC panel comprising a pair of substrates, and
filling the space between the pair of substrates with a Smectic liquid crystal material, while adjusting the liquid crystal molecular primary axis along with the pre-set or pre-designed alignment direction, and while adjusting the liquid crystal moving direction in the space between the pair of substrates at the filling of the Smectic liquid crystal material along with the pre-set alignment direction.

2. A process for producing a liquid crystal display device according to claim 1, wherein an external pressure is applied to the LC panel during the filling of the liquid crystal material so as to avoiding anonymous Marangoni flow due to surface tension.

3. A process for producing a liquid crystal display device comprising a Smectic liquid crystal material, while an external pressure is applied to LC panel during the filling of the liquid crystal material so as to avoiding anonymous Marangoni flow due to surface tension, the process comprising:
providing an LC panel comprising a pair of substrates, and
filling the space between the pair of substrates with a Smectic liquid crystal material, while adjusting the liquid crystal molecular primary axis along with the pre-set or pre-designed alignment direction, and while adjusting the liquid crystal moving direction in the space between the pair of substrates at the filling of the Smectic liquid crystal material along with the pre-set alignment direction.

4. A process according to claim 1, wherein the primary liquid crystal filling process uses pressure difference method.

5. A process according to claim 1, wherein the primary liquid crystal filling process uses ODF method.

6. A process according to claim 2, wherein the primary liquid crystal filling process uses pressure difference method.

7. A process according to claim 2, wherein the primary liquid crystal filling process uses ODF method.

8. A process according to claim 3, wherein the primary liquid crystal filling process uses pressure difference method.

9. A process according to claim 3, wherein the primary liquid crystal filling process uses ODF method.

10. A process according to claim 1, wherein the panel gap change is monitored on line during the filling process.

11. A process according to claim 2, wherein the panel gap change is monitored on line during the filling of the liquid crystal material.

12. A process according to claim 3, wherein the panel gap change is monitored on line during the filling of the liquid crystal material.

13. A process according to any of claims 10-12, wherein the panel gap monitoring method uses measurement of optical light throughput.

14. A process according to any of claims 10-12, wherein the panel gap monitoring method uses measurement of electrostatic capacitance.

15. A process according to claim 1, wherein the liquid crystal material shows Chiral Nematic phase.

16. A process according to claim 2, wherein the liquid crystal material shows Chiral Nematic phase.

17. A process according to claim 3, wherein the liquid crystal material shows Chiral nematic phase.
